(19) United States
(12) Patent Application Publication
(10) Pub. No.: US 2013/0221898 A1
(43) Pub. Date: Aug. 29, 2013

(54) Kinetic charging DC battery system for rolling luggage

(71) Applicant: Nathan J. Frost, New Albany, OH (US)

(72) Inventor: Nathan J. Frost, New Albany, OH (US)

(21) Appl. No.: 13/407,816

(22) Filed: Feb. 29, 2012

(51) Int. Cl. H02J 7/14; H02K 7/10

(52) U.S. Cl. 320/107; 290/1 C

(57) ABSTRACT

A device attached to the rolling wheel of a suitcase or similar luggage that converts wheel motion into electrical energy for charging a self contained battery. This battery is then used for charging or powering external electrical devices such as mobile phones, PDA's, tablets and laptop PC's

### BACKGROUND OF THE INVENTION

The invention is suitable for replacing restrictive methods of charging portable devices while traveling or commuting. Many business travelers, students and commuters do not have access to proper electrical outlets while traveling. The invention allows user to have constant access to portable charging station for portable electrical devices such as mobile phones, smart phones, PDA's, tablet devices, laptop PC's and more.

### SUMMARY OF THE INVENTION

The invention leverages the kinetic energy of a rolling wheel on a piece of luggage to charge an electrical system that allows charging and powering of external portable devices via USB (universal serial bus) connection. Depending on the device being charged or powered, (1) unit of time moving the wheels of the suitcase could yield (10 to 30) units of time powering external device(s).

DESCRIPTION

A jack-shaft driven by a wheel on the luggage turns a DC electrical generator/dynamo via specific gear or pulley reduction. This dynamo in turn charges a Lithium Polymer battery. The battery can supply 5V DC current via USB port to external devices. Battery capacity could range from (1000 to 4000) mAh. Higher voltage and higher capacity systems could be developed for powering full size laptop computers. The entire system fits inside the luggage in an enclosure similar in size to a pack of playing cards.

### BRIEF DESCRIPTION OF THE DRAWINGS

The present invention is further described in the detailed description which follows, in reference to the noted plurality of drawings by way of non-limiting examples of certain embodiments of the present invention, and wherein:

FIG. 1 shows a typical roll-around/roller suitcase;

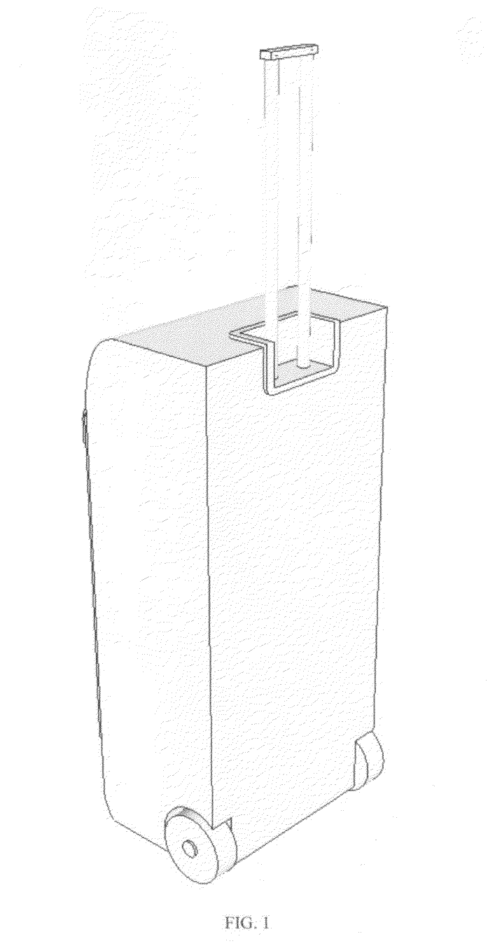

FIG. 2 shows a close up view of suitcase wheel or caster;

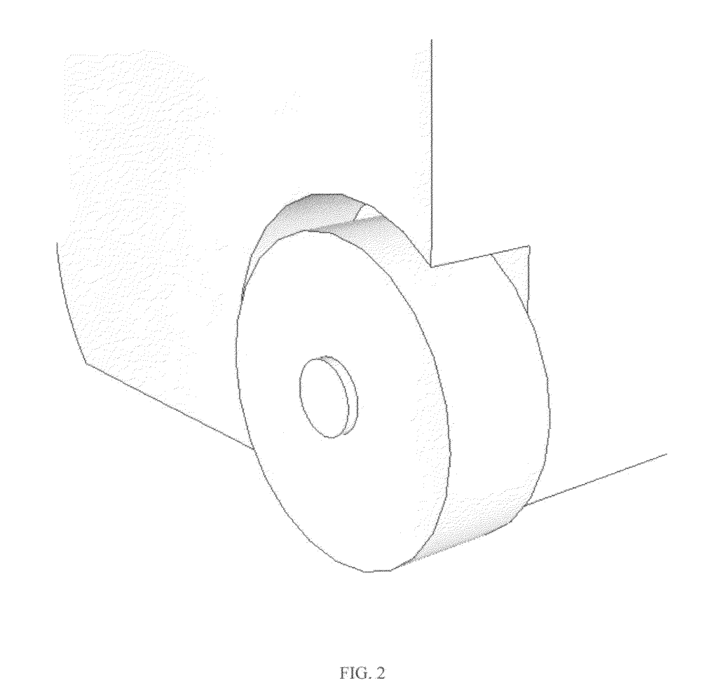

FIG. 3 shows transparent view of the system located in the luggage near the wheel/caster. The dynamo is driven directly or via jack-shaft by the wheel. The dynamo is connected to the LiPo battery for charging and finally a connection from the battery is supplied for connecting external devices;

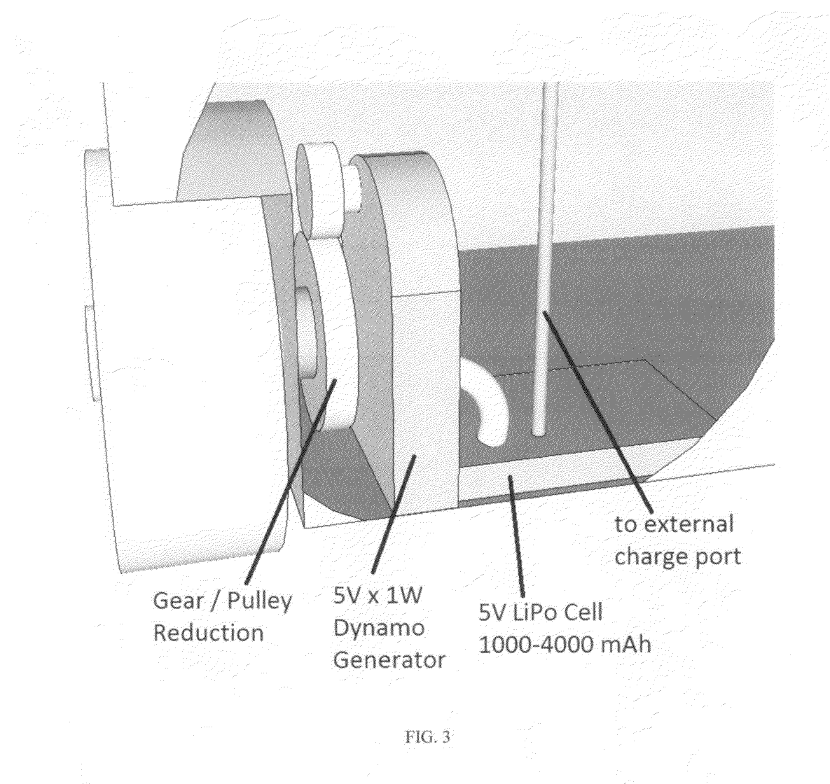

FIG. 4 shows a close up view of the external power connection (5V USB);

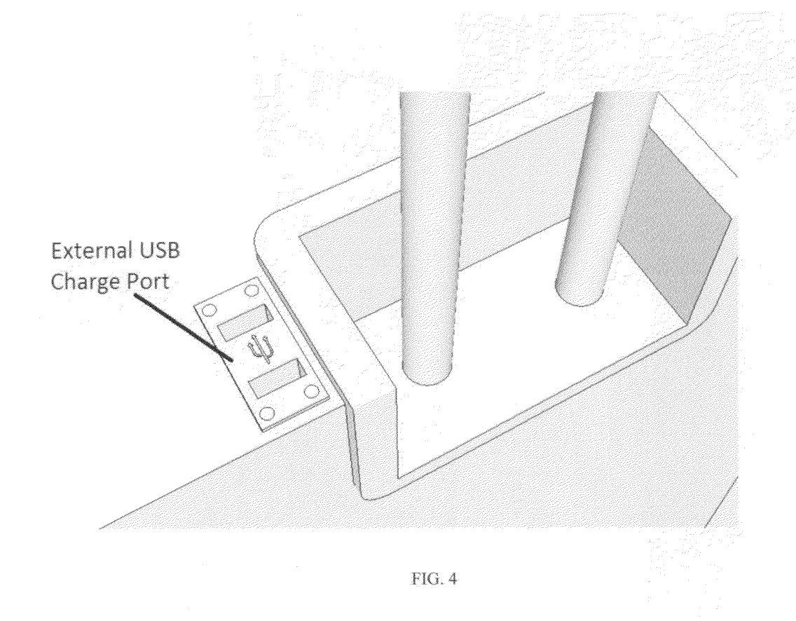

1. A method for transferring kinetic energy from suitcase wheel to dynamo/electrical generator.

2. A method for transferring electrical energy from dynamo/electrical generator to Lithium Polymer (LiPo) or similar Battery.

3. A method for simultaneously charging, storing and providing electrical energy for use of charging or powering devices external to the system.

4. (canceled)

5. (canceled)
